(19) United States
(12) Patent Application Publication
(10) Pub. No.: US 2005/0081584 A1
(43) Pub. Date: Apr. 21, 2005

(54) Security lock supporting master keying

(76) Inventor: Walter Joseph Nugent, Forest Victoria (AU)

Correspondence Address: CONNOLLY BOVE LODGE & HUTZ LLP, SUITE 800, 1990 M STREET NW, WASHINGTON, DC, 20036-3425, US

(21) Appl. No.: 10/491,484

(22) PCT Filed: Oct. 18, 2002
(86) PCT No.: PCT/AU02/01414

(30) Foreign Application Priority Data
Oct. 19, 2001 (AU) PR 8389

(51) Int. Cl. E05B 35/08; E05B 25/00

(52) U.S. Cl. 70/337; 70/382

(57) ABSTRACT

A lock of the type in which a latch means is able to be actuated if elongated members are able to pass through associated slots (54) in latch elements. There are two sets of latch elements (50) in two keyways (48, 49) such that, when the slots (54) in opposed pairs of elements are aligned, the actuating members can pass through. One set of latch elements (54) are positioned by a setter or biscuit (56) and the other set are positioned by a key (58) that corresponds to the shape of the setter to align the slots (54) of corresponding elements in each set. This type of lock is improved by providing at least one latch element (50) in one set (ie in one keyway 48 or 49), with a wider slot (54) to enable master keying. The master key is set to correspond to the highest or lowest position in the wide slot.

### BACKGROUND TO THE INVENTION

It has been a desirable feature of locks that they be able to be rekeyed without changing the lock. Another desirable feature is a lock that has a master key and subordinate keys which do not need a new lock mechanism when one of the keys needs to be replaced.

U.S. Pat. No. 4,741,188 discloses a pin tumbler lock in which keys can be replaced without changing the locks. This lock can also have a master key and subordinate keys. One difficulty with pin tumbler locks is the cost of manufacture because of the skilled machining and complex assembly required.

U.S. Pat. No. 4,898,011 disclosed an alternative lock to the pin tumbler which also avoided the need to change the lock. Instead of the key aligning pins to enable rotation of a cylinder the key aligned pins with slots so that elongate members could pass through to allow actuation of a latch. Each key had an associated biscuit which set one set of pins in position and the matching key aligned slots in a second set of pins with the slots of the first set. Master keying was possible by using more than one slot per pin.

Patent specification WO98/40589 discloses a programmable cylinder lock capable of having one or more levels of master key and able to be rekeyed. The cost of making such a lock and the capital cost of the machinery required to make it is very high.

It is an object of this invention to provide an inexpensive high security lock that can be rekeyed without changing the lock and which allows master keying on one or more levels.

### BRIEF DESCRIPTION OF THE INVENTION

To this end the present invention provides a lock of the type in which a latch means is able to be actuated if elongated members are able to pass through associated slots in latch elements wherein either the elongated members or the latch elements are positioned by a setter and the other of the latch elements or the elongated members are positioned by a key that corresponds to the shape of the setter to align the slots of the latch elements with the ends of the elongated members, the improvement being to provide at least one latch element with a wider slot to enable master keying.

This invention is an improvement in the lock arrangement of U.S. Pat. No. 4,898,011 and enables master keying at more than one level to be achieved. The content of U.S. Pat. No. 4,898,011 is incorporated herein by reference. When the latching elements are oriented vertically the wider slot extends vertically and is of greater height than the slots in the other latch elements. In the context of this invention wider in relation to the slot in the latching element means higher if the latching elements are oriented vertically. Throughout this specification a reference to slots in the latch elements mean both holes that pass through the body of the latch element or channel like passages that can accommodate and guide the elongated actuation members.

One embodiment of the lock has are two sets of latch elements such that, when the slots in each set of elements are aligned, the actuating members can pass through, wherein one set of latch elements are positioned by a setter and the other set are positioned by a key that corresponds to the shape of the setter to align the slots of corresponding elements in each set, the improvement being to provide at least one latch element in one set with a wider slot to enable master keying. When one set of latch members includes one member with a slot that is 5 positions wide, there are 5 corresponding slot positions in the matching element in the second set which will allow passage of the actuating members. This means that there are 5 coding positions which will allow 5 levels of entry to be controlled. The master key will be able to enter locks on all 5 levels the second highest level will not allow access to the master level but will allow entry to the 4 lowest levels. This hierarchy continues with the lowest level being accessible to all key holders but holders of the lowest level key being unable to access the higher level locks. The number of levels can be set from the width of the slot and the number of latch members with widened slots. The master key will normally be allocated a position corresponding to the bottom or top of the widened slots so that it may enter the other levels.

### DETAILED DESCRIPTION OF THE INVENTION

A preferred embodiment of the invention will be described with reference to the drawings in which

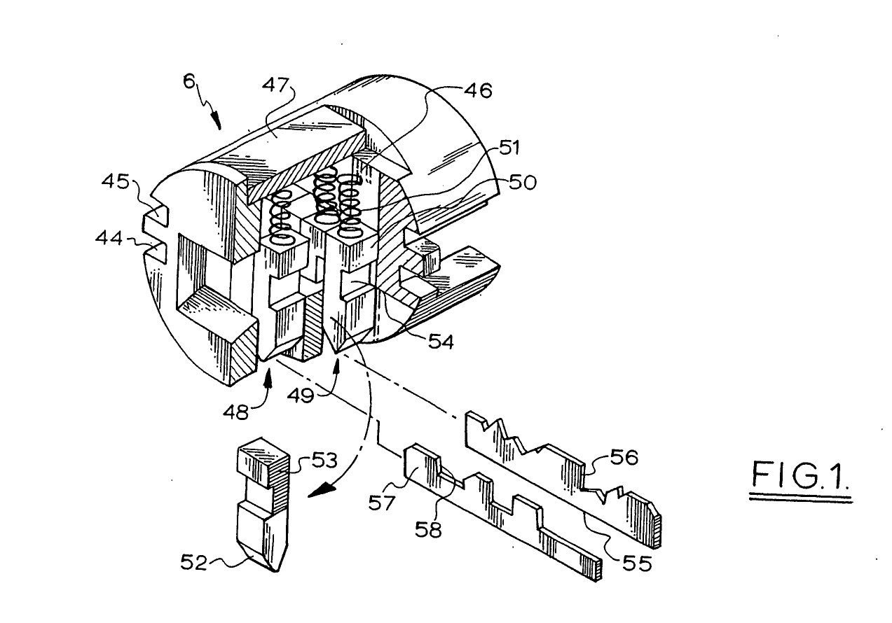

FIG. 1 is a schematic view of the key and setter arrangement of U.S. Pat. No. 4,898,011;

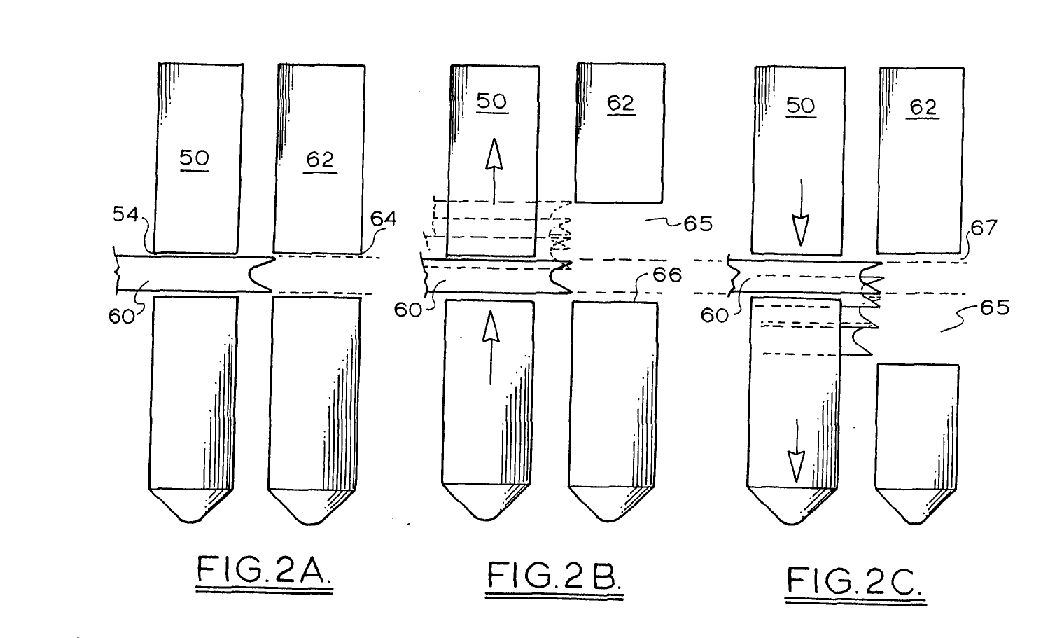

FIGS. 2A, 2B and 2C schematically illustrate the alignment of slots and the use of a wider slot to enable master keying.

As shown in FIG. 1, key 57 is inserted into keyway 48 in which a set of latch or pin elements 50 are biassed downwardly so that their lower ends 52 engage with the contoured edge 58 of key 57. Each of the latch elements 50 include a slot 54 for the passage of actuating members as described in U.S. Pat. No. 4,898,011.

A biscuit or programmable setter 55 having a contoured edge 56 corresponding to the edge 58 of key 57 is positioned in keyway 49. When the key 57 and the setter 55 are both inserted into their respective keyways 48 and 49 the slots 54 in each of the latch elements 50 in keyway 48 are aligned with the slots 54 in the latch elements in keyway 49.

This can be seen schematically in FIG. 2A. The latching elements 62 in the setter keyway 49 have a slot or passage 64 that is identical to the passage 54 in the latching element 50 of the key keyway 48. FIG. 2b shows a wide or high slot 65 in a latching element 62 for a setter where the bottom 66 of the slot 65 corresponds to the lowest position of a slot 54 in the corresponding element 50 for the key. Four positions or codes are possible which will all enable the actuating arm 60 to pass through both slots 54 and 65. These positions are obtained by increasing the height on the key contour corresponding to the latching element 50 by an increment which corresponds to a distance that is a fraction of the thickness of the actuator 60 up to the thickness of the actuator 60. By using a fraction of the thickness, the increment is smaller, which allows a larger number of incremental positions to be accommodated in a given sized latching element 50. The master key will be the key with the highest height for the key contour corresponding to that element 50. The key and setter will have corresponding contours which means that the lowest level setter will have the lowest contour height for that latching element and all higher keys including the master key will allow the actuator to pass through the slot. However for the lock with the master setter each of the lower level keys will not raise the key latching element high enough for the actuator to pass through the slot in the pin in the key row.

The reverse arrangement is shown in FIG. 2C where the 4 coding positions are obtained by incrementally decreasing the height of the key contour for that latch element 50. The top 67 of the slot 65 corresponds to the highest position of a slot 54 in the corresponding element 50 for the key. The master key has the lowest contour for that element which means that the lower level keys will not drop the latching element low enough for the actuator 60 to pass through the setter slot 65.

It is not necessary for the wide (high) slot 65 to be in the setter row 49 of latching elements 62. It is equally effective to have the wider slot in one of the elements 50 in the key row 48. More than one wide slot pin element (50, 62) may be used in the set.

The keys and setters may be colour coded so that allocation of the keys can be managed. This enables the one lock mechanism to be used for a large number of key combinations with 5 levels of entry. The whole set of keys and setters can be replaced by a new set of keys and setters or the lowest setter can be changed. This coding arrangement can be used in the lock mechanism as disclosed in U.S. Pat. No. 4,898,011 in which the lock is not actuated by rotation of the key or it may be used in the mechanism disclosed in co-pending application PR 8387 filed on the same date as this application by the present applicant.

It will also be clear to those skilled in the manufacture of locks that this invention is adaptable to any lock that utilises the alignment of slots in latch pins with the ends of actuating elements that pass through the slots to actuate the lock.

1. A lock of the type in which a latch means is able to be actuated if elongated members are able to pass through associated slots in latch elements wherein either the elongated members or the latch elements are positioned by a setter and the other of the latch elements or the elongated members are positioned by a key that corresponds to the shape of the setter to align the slots of the latch elements with the ends of the elongated members, the improvement being to provide at least one latch element with a wider slot to enable master keying.

2. A lock as claimed in claim 1 in which there are two sets of latch elements such that, when the slots in each set of elements are aligned, the actuating members can pass through, wherein one set of latch elements are positioned by a setter and the other set are positioned by a key that corresponds to the shape of the setter to align the slots of corresponding elements in each set, the improvement being to provide at least one latch element in one set with a wider slot to enable master keying.

3. A lock as claimed in claim 1 in which the width of the slots correspond to the thickness of the elongated actuation members and the wider slot is the width of the slot plus one or more increments which range in size from a fraction of the thickness of the actuation member to a whole thickness of the actuation member.

4. A lock as claimed in claim 3 in which the wide slot has up to 5 increments in addition to the width of the elongated actuating member.

5. A lock as claimed in claim 2 in which the width of the slots correspond to the thickness of the elongated actuation members and the wider slot is the width of the slot plus one or more increments which range in size from a fraction of the thickness of the actuation member to a whole thickness of the actuation member.

6. A lock as claimed in claim 5 in which the wide slot has up to 5 increments in addition to the width of the elongated actuating member.
